(19) United States
(12) Patent Application Publication
(10) Pub. No.: US 2026/0267576 A1
(43) Pub. Date: Sep. 10, 2026

(54) NON-TRANSITORY COMPUTER READABLE STORAGE MEDIUM

(71) Applicant: BROTHER KOGYO KABUSHIKI KAISHA, Nagoya (JP)

(72) Inventors: Airi EGUCHI, Ichinomiya (JP); Yoshito HOSOMIZO, Konan (JP); Kenju NARITA, Nagoya (JP)

(21) Appl. No.: 19/660,579

(22) Filed: Apr. 28, 2026

Related U.S. Application Data
(63) Continuation of application No. PCT/JP2024/045153, filed on Dec. 20, 2024.

(30) Foreign Application Priority Data
Jan. 31, 2024 (JP) 2024-012674

(51) Int. Cl. G06F 3/12

(52) U.S. Cl. CPC G06F 3/1232; G06F 3/1205

(57) ABSTRACT

A non-transitory computer readable storage medium storing a support program that is executable by a computer of an information processing device, corresponds to a printer, and supports a general-purpose printing program incorporated in an operating system. At least one of the general-purpose printing program and the support program causes the computer to communicate with the printer to acquire capability information, and store the acquired capability information in a memory. The general-purpose printing program causes the computer to receive a print setting based on the capability information. The support program includes a generation process of generating display data to be displayed on a first print setting screen, an acquisition process of acquiring operation information from an editing application program, and an update process of acquiring the capability information from the printer in response to the operation information being acquired and updating the capability information stored in the memory.

### REFERENCE TO RELATED APPLICATIONS

This is a continuation application of International Application No. PCT/JP2024/045153 filed on December 20, 2024, which claims priority from Japanese Patent Application No. 2024-012674 filed on January 31, 2024. The entire contents of the aforementioned applications are incorporated herein by reference.

### BACKGROUND ART

In recent years, a technique has been put into practical use in which a printer is controlled by an OS-standard general-purpose printing program that is part of the operating system (OS), without using a printer driver provided by a printer vendor. With this technique, when the OS detects a printer, association with the OS-standard general-purpose printing program is performed, and thereafter, when a print instruction for the printer is received, the OS-standard general-purpose printing program generates print data without using the printer driver provided by the printer vendor, making it possible to print using the OS-standard general-purpose printing program.

For example, a related art discloses a technique related to an OS-standard general-purpose printing program. The related art discloses a support program that supports a general-purpose printing program, which, if capability dependent information based on capability information of a printer is cached at a timing when the printer is selected, reads the cached capability dependent information, and if the capability dependent information is not cached, acquires the capability information from the printer and caches the capability dependent information based on the acquired capability information.

The capability of the printer changes depending on the status of the printer, such as attachment and detachment of additional trays. For this reason, if the capability information of the printer is acquired when the printer is selected, data based on the capability information is cached, and then the cached capability information is used as in the configuration of the related art, a current capability of the printer may not be accommodated.

### SUMMARY

A non-transitory computer readable storage medium storing a support program for solving the above-described problems, the support program is executable by a computer of an information processing device, corresponds to a printer connected to the information processing device, and supports a general-purpose printing program incorporated in an operating system of the information processing device. At least one of the general-purpose printing program and the support program causes the computer to communicate with the printer to acquire capability information indicating a capability of the printer, and store the acquired capability information in a memory of the information processing device. The general-purpose printing program is configured to cause the computer to receive a print setting for causing the printer to execute printing based on the capability information stored in the memory. The support program is configured to cause the computer to execute a generation process of generating display data to be displayed on a first print setting screen, in which the first print setting screen is a print setting screen to be displayed by an editing application program incorporated in the information processing device, the first print setting screen includes a first operator that receives an operation for updating the capability information, and the generated display data is passed to the editing application program via the general-purpose printing program to display the first print setting screen according to the display data. The support program further causes the computer to execute: an acquisition process of acquiring operation information from the editing application program when an operation on the first operator included in the first print setting screen is received via a user interface of the information processing device; and an update process of acquiring the capability information from the printer in response to the operation information being acquired and updating the capability information stored in the memory.

A non-transitory computer readable storage medium storing a support program that is executable by a computer of an information processing device, corresponds to a printer connected to the information processing device, and supports a general-purpose printing program incorporated in an operating system of the information processing device. At least one of the general-purpose printing program and the support program causes the computer to communicate with the printer to acquire capability information indicating a capability of the printer, and store the acquired capability information in a memory of the information processing device. The support program is configured to cause the computer to receive a print setting for causing the printer to execute printing based on the capability information stored in the memory. The support program causes the computer to execute a receiving process of receiving an operation for updating the capability information via a user interface of the information processing device. The support program further causes the computer to execute, in response to reception of the operation in the receiving process, an update process of acquiring the capability information from the printer and updating the capability information stored in the memory.

### BRIEF DESCRIPTION OF THE DRAWINGS

FIG. 1 is a block diagram showing an outline of an electrical configuration of a PC.

FIG. 2 is a sequence diagram showing an example of a print setting procedure.

FIG. 3 is a diagram showing an example of a print setting screen.

FIG. 4 is a sequence diagram showing an example of an update operation reception procedure.

FIG. 5 is a sequence diagram showing an example of a print setting procedure.

FIG. 6 is a diagram illustrating an example of the detailed setting screen.

FIG. 7 is a diagram illustrating an example of an update selection screen.

FIG. 8 is a sequence diagram showing an example of a capability update procedure.

### DESCRIPTION

Hereinafter, a personal computer (hereinafter, referred to as a "PC") that uses a support program according to the present aspect will be described in detail with reference to the accompanying drawings. The present description discloses a support program to be executed on the PC.

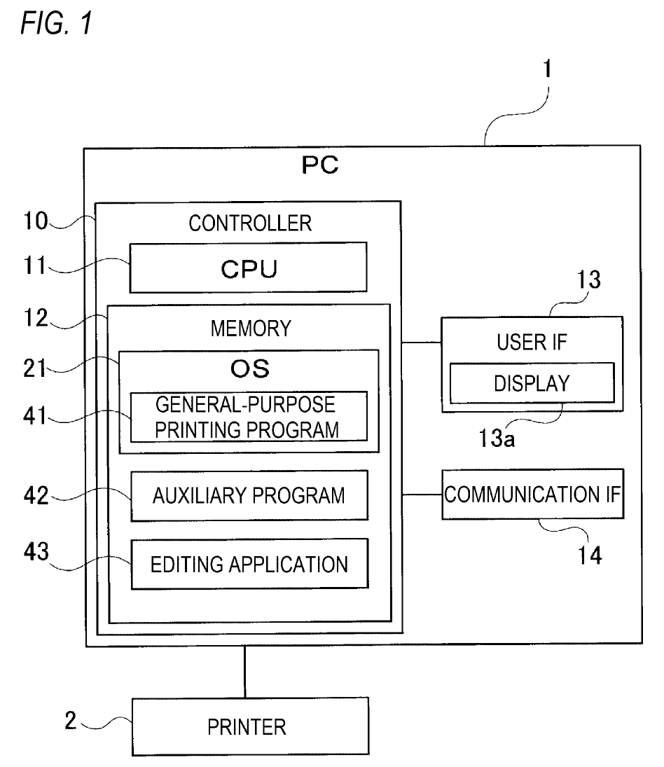

As illustrated in FIG. 1, a PC 1 according to the present aspect includes a controller 10 including a CPU 11 and a memory 12. The PC 1 is an example of the information processing device. The CPU 11 is an example of the computer. The PC 1 includes a user interface (hereinafter, referred to as a "user IF") 13, and a communication interface (hereinafter, referred to as a "communication IF") 14 that are electrically connected to the controller 10. The controller 10 in FIG. 1 is a collective term for hardware and software used to control the PC 1, and does not necessarily represent a single piece of hardware actually present in the PC 1.

The CPU 11 of the PC 1 is configured to execute various types of processes, in accordance with a program read from the memory 12 and based on a user operation. The memory 12 stores various programs and various data. The memory 12 is used as a work area in a case where various types of processes are executed. A buffer provided in the CPU 11 is also an example of the memory. An example of the memory 12 is not limited to a ROM, a RAM, a HDD, and the like built into the PC 1, but may also be a storage medium that can be read and written by the CPU 11, for example, a recording medium such as a CD-ROM, and a DVD-ROM.

The user IF 13 includes a display 13a which is hardware that displays a screen for reporting information to a user, and hardware that receives an operation from the user. The user IF 13 may be a combination of the display 13a capable of displaying information and a mouse, a keyboard, or the like having an input receiving function, or may be a touch panel having the functions of the display 13a and the input receiving function.

The communication IF 14 includes hardware for communicating with an external device such as a printer 2. Communication standards of the communication IF 14 include Ethernet (registered trademark), Wi-Fi (registered trademark), USB, and the like. The PC 1 may be connectable to the Internet via the communication IF 14. The PC 1 may include a plurality of communication IFs 14 corresponding to a plurality of communication standards.

As shown in FIG. 1, the memory 12 stores various programs and various data including an operating system (hereinafter, referred to as "OS") 21 including a general-purpose printing program 41, an auxiliary program 42, and an editing application 43. The auxiliary program 42 is an example of the support program. The editing application 43 is an example of the editing application program.

The OS 21 is a multitasking OS that can process a plurality of tasks in parallel by managing and switching between the plurality of tasks. The OS 21 is, for example, Windows (registered trademark), macOS (registered trademark), Linux (registered trademark), iOS (registered trademark), or Android (registered trademark).

The OS 21 includes the general-purpose printing program 41. The general-purpose printing program 41 is an OS-standard program prepared by a vendor of the OS 21 and provided as a part of the OS 21. That is, the PC 1 is equipped with the OS 21 having the general-purpose printing program 41. The general-purpose printing program 41 is not configured to use a printer driver specific to each printer.

The general-purpose printing program 41 is a program having a function of causing printers of a plurality of types of models respectively provided by a plurality of vendors to execute printing based on an instruction of a user. The general-purpose printing program 41 supports a general-purpose function that enable printing to be performed on many printers. Unlike a printer driver specific to each printer, the general-purpose printing program 41 does not support functions specific to each printer or printer driver, in particular, functions that require complex processes.

The general-purpose printing program 41 is a program that includes a function of receiving image data designated as a printing target by a print instruction output from various applications based on an instruction of a user, and generating intermediate data based on the image data. The intermediate data is, for example, XPS data. The general-purpose printing program 41 further has a function of generating print data in a format that can be used for printing on various printers, based on the intermediate data. The print data is, for example, PWG Raster data or PDF data. The general-purpose printing program 41 has a function of transmitting the generated print data to a printer designated as a device to execute printing, via a communication function of the OS 21.

The auxiliary program 42 is a program or a group of programs that executes processes based on an instruction from the OS 21 in conjunction with the process of the general-purpose printing program 41, and is a program that supports the control of target hardware. The auxiliary program 42 of the present aspect corresponds to a model of the printer 2 connected to the PC 1, and is provided by, for example, the vendor of the printer 2. The general-purpose printing program 41 activates the auxiliary program 42 compatible with the printer 2 when the printer 2 is selected as a device for executing printing, when an instruction for detailed print settings is received in a state where the printer 2 is selected, when an instruction for causing the printer 2 to execute printing is received, or the like. The auxiliary program 42 is called, for example, a print support application (abbreviated as PSA) or a hardware support application (abbreviated as HSA).

The auxiliary program 42 may be a combination of a plurality of programs each of which receives an execution command, or may be one single program that can execute different processes in response to commands. Further, the auxiliary program may be a program prepared for each type of printer by the vendor of the printer. For example, an auxiliary program for an inkjet printer and an auxiliary program for a laser printer may be prepared separately. The auxiliary program may be prepared not only for each type of printer, but also for each model of printer or each series of printer models.

For example, when a new printer is connected to the PC 1, the OS 21 of the PC 1 can download an appropriate auxiliary program from a server or the like of the vendor of the printer or storage specified by OS 21 according to the type or model of the connected printer and incorporate the auxiliary program into the PC 1. The OS 21 stores identification information of the incorporated auxiliary program in the memory 12 in association with printer information of the newly connected printer.

The editing application 43 is, for example, a program for creating and editing image data and document data. The editing application 43 may be, for example, Microsoft Word (registered trademark) or PowerPoint (registered trademark) manufactured by Microsoft (registered trademark), or may be a program provided by the vendor of the printer 2. The editing application 43 can receive, via the user IF 13, a print execution instruction to cause the printer 2 to execute printing, for example. The editing application 43 is not limited to a program for creating or editing data, and may be a program that has a function of receiving a display instruction or a print instruction for various kinds of information such as map information or a web page in response to user requests.

The PC 1 of the present aspect is connected to the printer 2 via the communication IF 14 as shown in FIG. 1. The printer 2 is a device that has at least a printing function and a communication function. For example, when receiving print data from the PC 1 or the like, the printer 2 can execute printing based on the received print data. The printer 2 may be a device capable of color printing, or may be a device capable of only monochrome printing.

Next, the procedure of a process related to printing by the printer 2 in the PC 1 of the present aspect will be described. Each process other than the operation of a user in the present aspect basically indicates a process of the CPU 11 according to instructions written in a program such as the auxiliary program 42. In the present specification, various processes performed by the controller 10 or the CPU 11 according to programs such as the auxiliary program 42, the general-purpose printing program 41, and the OS 21 may be described as if each program were performing the various processes independently for convenience. The process executed by the CPU 11 also includes control of hardware using API of the OS 21. In the present specification, a detail description of the OS 21 is omitted, and an operation of each program is described. The term "acquisition" is used as a concept indicating that a request is not essential.

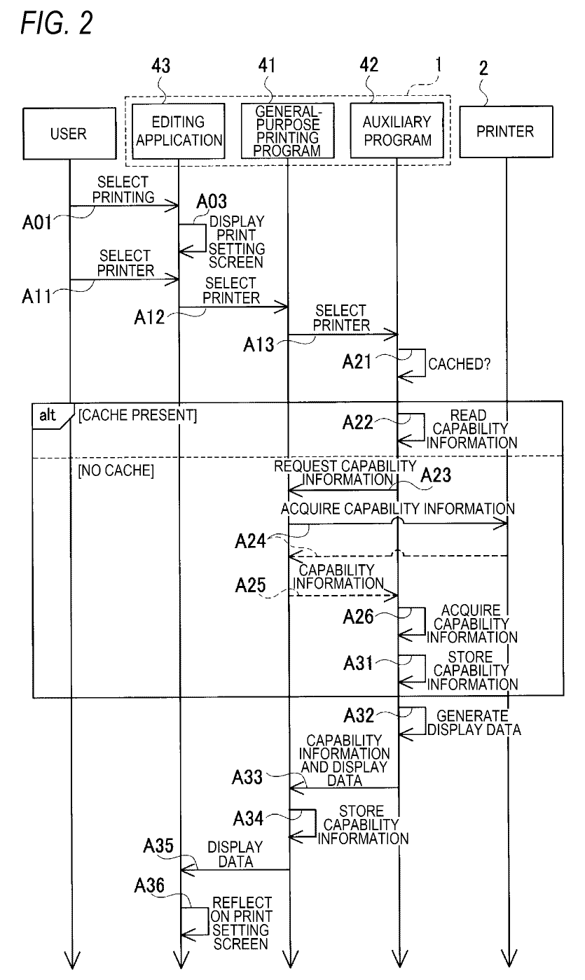

First, a print setting procedure for selecting a printer to be used for printing and receiving an instruction for print settings will be described with reference to the sequence diagram of FIG. 2. The editing application 43 can create and edit text and images based on an instruction from the user. If the user intends to print a text or image being displayed, the user selects print in the editing application 43 (A01). The user can select print from a menu of operation items provided in the editing application 43, for example.

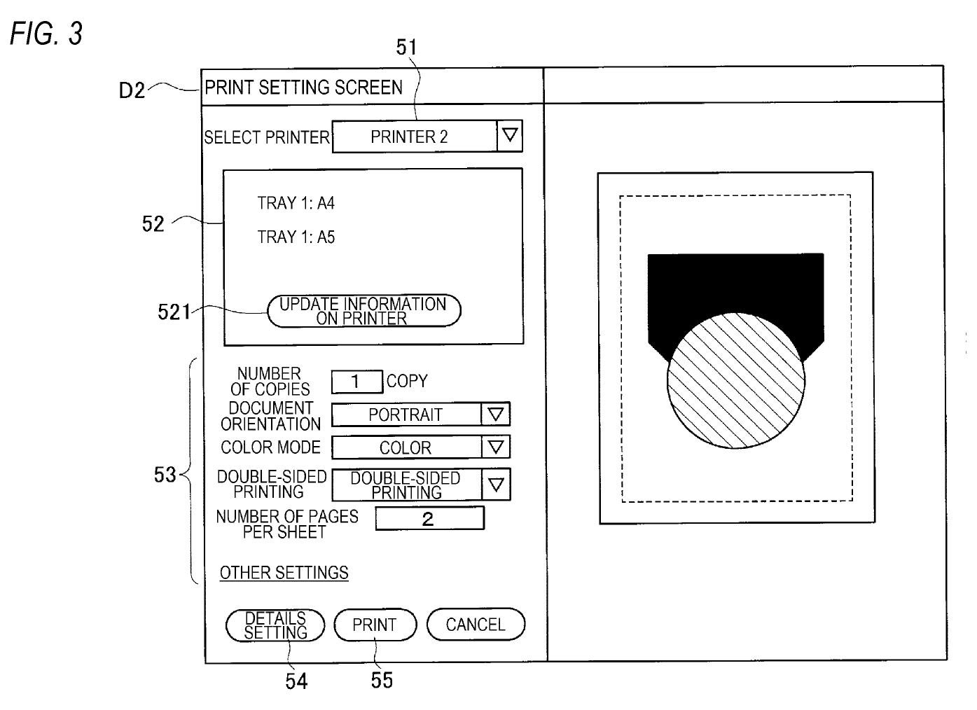

When the editing application 43 receives the selection of printing, a print setting screen is displayed on the user IF 13 (A03). For example, as illustrated in FIG. 3, the print setting screen is a screen that receives a user instruction regarding basic print settings that can be received by the general-purpose printing program 41 and the editing application 43. The display of the print setting screen may be performed by the general-purpose printing program 41.

A print setting screen D2 illustrated in FIG. 3 includes a printer selection field 51, an information display field 52, a basic print setting selection field 53, a detailed setting button 54, and a print button 55. The print setting screen D2 is an example of the first print setting screen.

The printer selection field 51 is a field for receiving the selection of a device to be used for printing. The information display field 52 is a field for displaying information designated by the auxiliary program corresponding to the device selected in the printer selection field 51. The display content of the information display field 52 will be described later.

The basic print setting selection field 53 is a field for receiving basic settings such as the number of copies to be printed and an orientation of a document. The detailed setting button 54 is a button for receiving an instruction to perform detailed settings not included in the basic print setting selection field 53. The print button 55 is a button for receiving an instruction to execute printing with the selected print settings.

For example, in a case where a selection instruction to select the printer 2 as a device to execute printing is received in the printer selection field 51 (A11), or in a case where selection of printing in A01 is received with the printer 2 selected as the device to execute printing, the editing application 43 passes information indicating that the printer 2 is selected to the general-purpose printing program 41 (A12). The general-purpose printing program 41 activates the auxiliary program 42 corresponding to the printer 2 and passes information indicating that the printer 2 has been selected (A13).

When the auxiliary program 42 is activated in response to the instruction from A13, the auxiliary program 42 acquires the capability information of the printer 2. The auxiliary program 42 first determines whether the capability information of the printer 2 is cached in the memory 12 (A21). If it is determined that the capability information is stored in the memory 12 (alt: [cache present]), the auxiliary program 42 reads the stored capability information from the memory 12 (A22).

If it is determined that the capability information is not stored in the memory 12 (alt: [no cache]), the auxiliary program 42 acquires the capability information of the printer 2. Specifically, the auxiliary program 42 requests the general-purpose printing program 41 to acquire the capability information (A23). The general-purpose printing program 41 transmits a command requesting the capability information to the printer 2 and acquires the capability information from the printer 2 (A24). The general-purpose printing program 41 passes the acquired capability information to the auxiliary program 42 (A25). Accordingly, the auxiliary program 42 can acquire the capability information of the printer 2 (A26).

It is noted that the general-purpose printing program 41 performs communication with the printer 2 via the OS 21 in A24, for example, by communication according to internet printing protocol (IPP). Instead of making a request to the general-purpose printing program 41, the auxiliary program 42 may acquire the capability information directly from the printer 2 using, for example, a management information base (MIB).

The capability information acquired from the printer 2 includes information on setting items that can be set as print settings and parameters that can be set for each setting item. Further, the capability information includes, for example, information on items related to the sheet feeding trays and sheet discharging trays available to the printer 2, such as information indicating the selectable sheet feeding trays and sheet discharging trays, and sheet information such as the sheet size and sheet type of the sheet set in each sheet feeding tray. The capability information may further include information on the print resolution that printer 2 can support, information on the image processing function that printer 2 can execute, information indicating the status of printer 2 such as remaining amount of consumables, information indicating exclusive settings and how to resolve them, and information indicating default print settings. The capability information is used, for example, when the general-purpose printing program 41 or the editing application 43 displays a print setting screen or when determining an exclusive error in the print settings.

The auxiliary program 42 stores the acquired capability information in the memory 12 (A31). The auxiliary program 42 may store the capability information that can be used by the general-purpose printing program 41 or the editing application 43 in an area used by the general-purpose printing program 41 or the editing application 43, and share the information.

After A22 or A31, based on the capability information acquired in A22 or A26, the auxiliary program 42 generates display data indicating the content to be displayed in the information display field 52 of the print setting screen D2 or the content to be displayed in the basic print setting selection field 53 (A32). A32 is an example of the generation process. The auxiliary program 42 generates the display data for displaying an update button 521 in the information display field 52, as shown in FIG. 3, for example. The update button 521 is a button that receives an operation for updating the capability information of the printer 2, and is an example of the first operator.

Further, the auxiliary program 42 passes the acquired capability information and the generated display data to the general-purpose printing program 41 (A33). The general-purpose printing program 41 stores the received capability information in the memory 12 (A34). The general-purpose printing program 41 may share the capability information passed from the auxiliary program 42 with the editing application 43 by, for example, storing the capability information in a common area of the memory 12. Further, the general-purpose printing program 41 passes the display data to the editing application 43 (A35). The auxiliary program 42 may directly pass the display data to the editing application 43.

The editing application 43 reflects the new capability information and the received display data on the print setting screen D2 displayed in A03 (A36). The editing application 43 may, for example, refer to information on the print settings shared with the general-purpose printing program 41 and display the print setting screen D2. Furthermore, the editing application 43 displays the information generated by the auxiliary program 42 in the information display field 52 based on the display data. As a result, the information display field 52 including an update button 521 is displayed on the print setting screen D2, as shown in FIG. 3.

In A03, the editing application 43 displays the print setting screen D2 based on the information held by the general-purpose printing program 41 or the editing application 43. Then, based on the information passed from the auxiliary program 42 in A33, the general-purpose printing program 41 or the editing application 43 update and display the print setting screen D2 in A35. For example, when capability information indicating that an additional tray has been newly installed in the printer 2 is received, the editing application 43 updates the basic print setting selection field 53 so that the additional tray is included in the options, and displays the print setting screen D2.

The capability information stored in the memory 12 in A31 and the capability information passed to the general-purpose printing program 41 or editing application 43 in A33 may be information that includes all of the capability information acquired from the printer 2, or may be information that includes only part of the capability information acquired from the printer 2. For example, the capability information passed to the general-purpose printing program 41 or the editing application 43 may be only information about print settings that can be accepted by the general-purpose printing program 41 or the editing application 43.

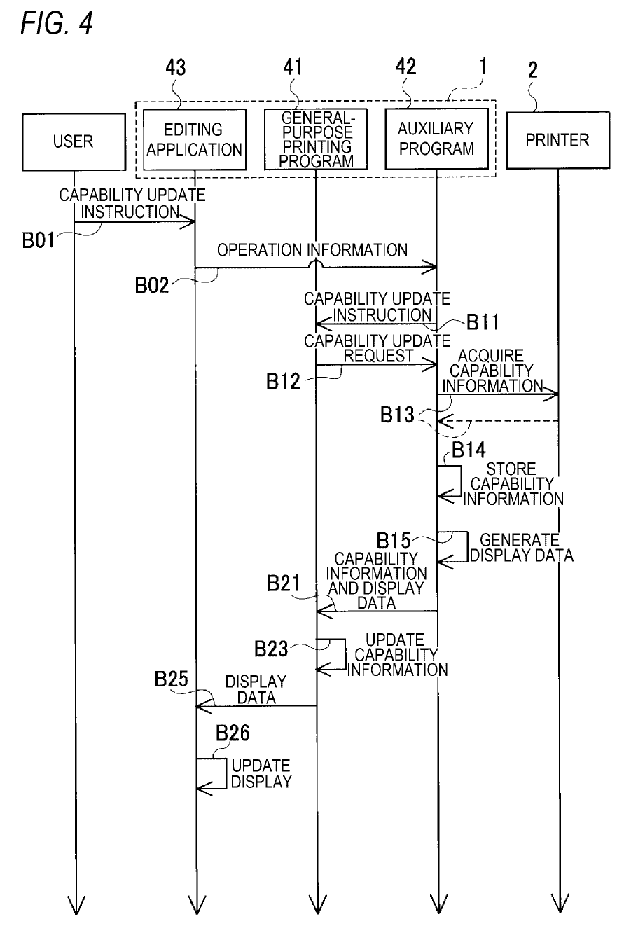

Then, the editing application 43 becomes able to receive a user operation on the print setting screen D2 being displayed. An update operation reception procedure, which is a procedure when an operation on the update button 521 is received as a user operation on the print setting screen D2, will be described with reference to the sequence diagram of FIG. 4.

When the editing application 43 receives an operation on the update button 521 of the information display field 52 as a user operation on the print setting screen D2 (B01), operation information, which is information on the received operation, is passed to the auxiliary program 42 (B02). B01 is an example of the receiving process.

In response to receiving operation information indicating the operation on the update button 521, the auxiliary program 42 outputs a capability update instruction to the general-purpose printing program 41 (B11). When the general-purpose printing program 41 receives the capability update instruction, the general-purpose printing program 41 outputs a capability update request to the auxiliary program 42 (B12). The capability update request is an instruction from the general-purpose printing program 41 to the auxiliary program 42 requesting information for updating the capability information held in the general-purpose printing program 41. The auxiliary program 42 can receive a capability update request from the general-purpose printing program 41 by outputting the capability update instruction to the general-purpose printing program 41.

Upon receiving the capability update request, the auxiliary program 42 acquires the current capability information from the printer 2 (B13). The auxiliary program 42 may acquire the capability information by making a direct request to the printer 2, or may acquire the capability information via the general-purpose printing program 41 by making a request to the general-purpose printing program 41, as in A23 to A25 of FIG. 2. Further, the auxiliary program 42 stores the acquired capability information in the memory 12 (B14). B14 is the same process as A31 of FIG. 2, and is a process for updating the information stored in A31. B14 is an example of the update process.

The auxiliary program 42 generates new display data indicating the content to be displayed on the print setting screen D2 based on the capability information acquired in B13 (B15). B15 is an example of the generation process. Further, the auxiliary program 42 passes the acquired capability information and the generated display data to the general-purpose printing program 41 (B21). As a result, the general-purpose printing program 41 updates the information stored in the memory 12 based on the capability information received from the auxiliary program 42 in B21 (B23). B21 is an example of the update process.

Further, the general-purpose printing program 41 passes the display data to the editing application 43 (B25). As a result, the editing application 43 reflects the new display data and displays the print setting screen D2 on the user IF 13 (B26).

For example, if the sheet set in the sheet feeding tray is changed after the print setting screen D2 based on the capability information of printer 2 is displayed at A35 in FIG. 2, the parameters selectable in the basic print setting selection field 53 may change. Further, for example, if the coloring materials for color printing run out and the color printing becomes impossible, the printer 2 may only accept a print instruction in which the color setting is set to monochrome printing. The auxiliary program 42 passes the updated capability information to the general-purpose printing program 41, so that a print setting screen D2 including selectable parameters as options is displayed in response to the change in the capability of the printer 2.

The auxiliary program 42 can display the information display field 52 including the update button 521 on the print setting screen D2 displayed by the editing application 43, and can receive an instruction to update the capability information by the user operating the update button 521. Therefore, the user can update the capability information at any timing while the print setting screen D2 is being displayed. Further, when the capability information is updated by the user operating the update button 521, the auxiliary program 42 causes the editing application 43 to update the display content of the print setting screen D2, thereby enabling display that corresponds to the change in the capability of the printer 2.

The auxiliary program 42 may skip B15 if the difference between the acquired capability information and the previous capability information is small enough that the display data does not need to be changed. In this case, the auxiliary program 42 may pass only the capability information to the general-purpose printing program 41 in B21. As a result, both B25 and B26 may be skipped.

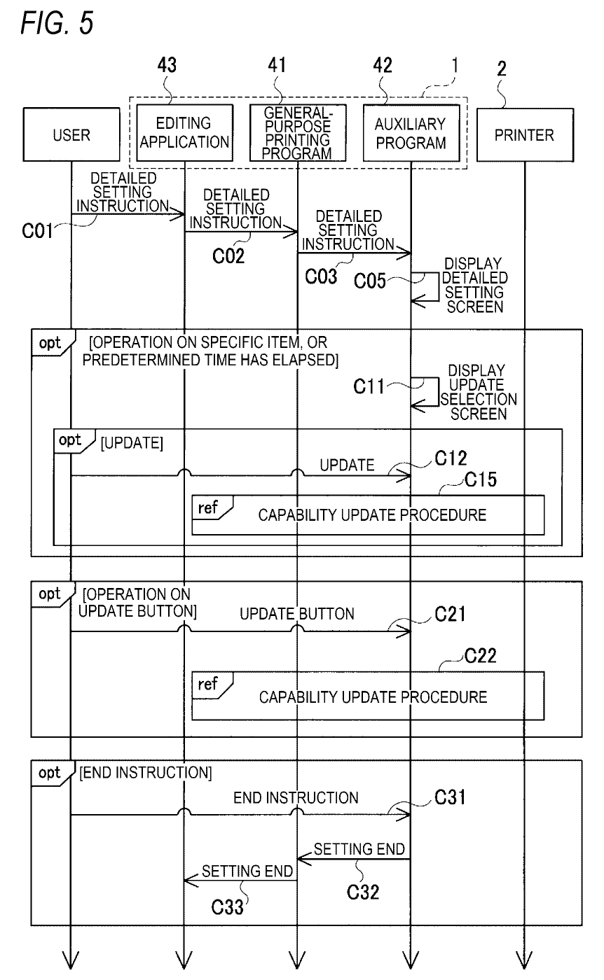

The editing application 43 can also receive an operation on the detailed setting button 54 as a user operation on the print setting screen D2 currently being displayed. A detailed setting procedure, which is the procedure when the detailed setting button 54 is operated, will be described with reference to the sequence diagram of FIG. 5.

When an instruction for detailed print settings is received by operating the detailed setting button 54 (C01), the editing application 43 outputs the instruction for detailed settings, that is, an instruction to display a setting screen for receiving the detailed print settings, to the general-purpose printing program 41 (C02). The general-purpose printing program 41 activates the auxiliary program 42 corresponding to the printer 2 and passes an instruction to start receiving the detailed print settings (C03). In C03, the general-purpose printing program 41 passes the information of the print setting currently received to the auxiliary program 42.

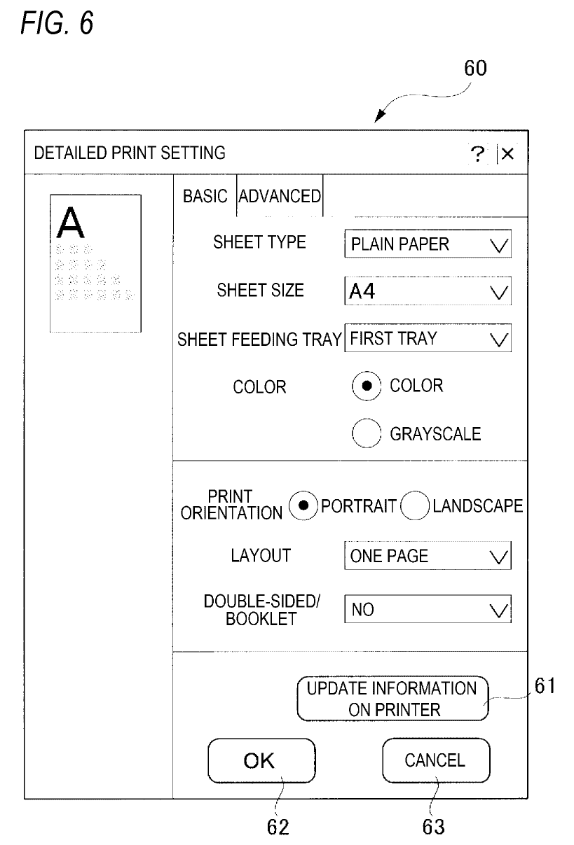

When the auxiliary program 42 is activated based on the instruction for detailed print settings, a detailed setting screen 60 is displayed on the user IF 13 (C05), as shown in FIG. 6, to receive a user operation. C05 is an example of the display process. The detailed setting screen 60 is an example of the print setting screen, and is an example of the second print setting screen. The instruction of C01 is also an instruction to display the detailed setting screen 60.

The detailed setting screen 60 displayed by the auxiliary program 42 includes, for example, an update button 61 for receiving an instruction to update the capability information, an "OK" button 62, and a "Cancel" button 63. Further, the auxiliary program 42 can display the parameters that can be set for each item of print settings as options for that item, based on the capability information of the printer 2. Since there are many print setting items that can be received on the detailed setting screen 60, the auxiliary program 42 may be able to receive an instruction to switch the items to be selected using a plurality of tabs, for example.

The auxiliary program 42 receives a user operation on the detailed setting screen 60 displayed in C05. For example, when the auxiliary program 42 receives an operation to each item of print settings, the auxiliary program 42 changes and displays the parameter selected for the item based on the user operation. The auxiliary program 42 copies the information of the print setting received in C03 and changes the copied information based on the user operation.

When a user operation on a specific item is received, or when the auxiliary program 42 determines that the elapsed time since the detailed setting screen 60 is displayed exceeds a predetermined threshold time (opt: [operation on specific item, or predetermined time has elapsed]), an update selection screen is displayed on the user IF 13 (C11).

The specific item is an item for which selectable parameters of the print settings may change due to a change in the capability of the printer 2. As described above, for example, when the user changes the sheet set in the sheet feeding tray installed in the printer 2, the parameters that can be selected in the item of sheet information change. The specific items are, for example, a sheet feeding tray, a sheet discharging tray, a sheet size, a sheet type, and a color setting. On the other hand, for items such as the number of copies and the print orientation, the parameters that can be set do not change even if the capability of the printer 2 changes. An item for which the parameter that can be set does not change even if the capability of the printer 2 changes is not the specific item.

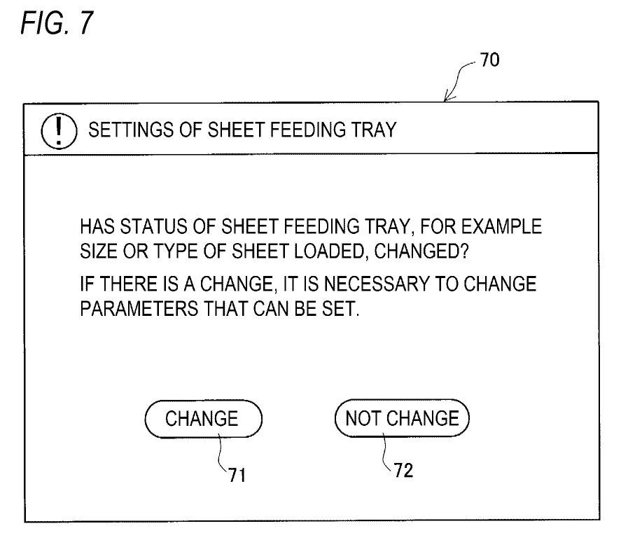

For example, when the auxiliary program 42 receives a user operation on an item related to the sheet feeding tray, specifically, when it receives an operation on any of the items including sheet type, sheet size, or sheet feeding tray on the detailed setting screen 60 shown in FIG. 6, the auxiliary program 42 performs the process of C11. In C11, the auxiliary program 42 displays an update selection screen 70, as shown in FIG. 7, which inquires whether the capability of the printer 2 is changed and whether to update the capability information of the printer 2, and receives the selection from the user. The update selection screen 70 includes, for example, a "change" button 71 for receiving an instruction to change the capability, and a "not change" button 72 for receiving an instruction not to change the capability. C11, which is performed when a user operation on a specific item is received, is an example of a first selection process.

For example, the auxiliary program 42 compares the elapsed time after the detailed setting screen 60 is displayed in C05 or after the detailed setting screen 60 is updated and displayed in a procedure described below with a predetermined threshold time. If a time exceeding the predetermined threshold time has passed since the last time the capability information is acquired, the capability of the printer 2 may have changed. In this case, the auxiliary program 42 also displays a screen similar to that shown in FIG. 7 in C11 to inquire whether the capability of the printer 2 is changed. C11, which is executed when it is determined that the elapsed time since the detailed setting screen 60 is displayed exceeds the predetermined threshold time, is an example of the second selection process.

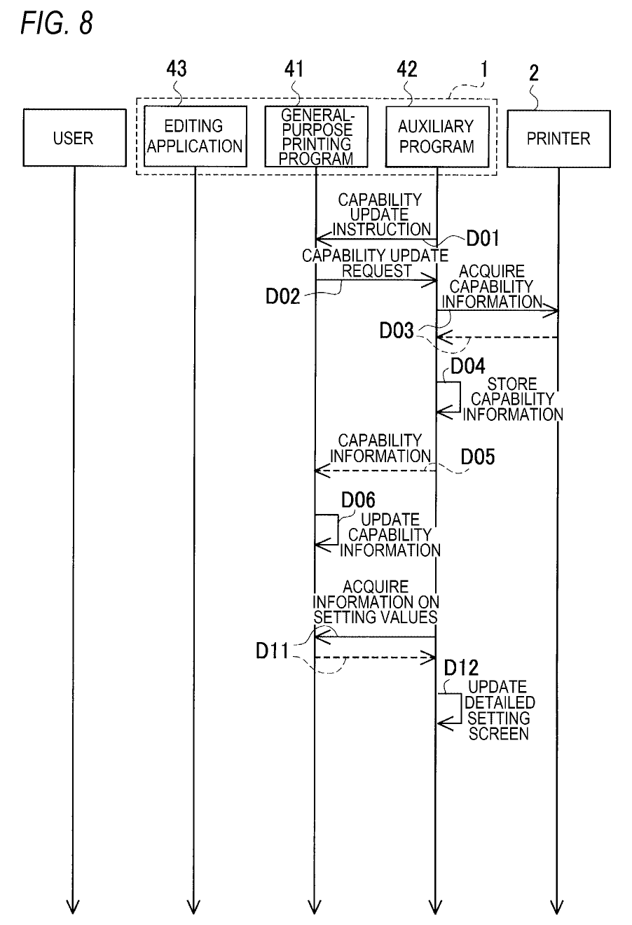

When the auxiliary program 42 receives an operation on the "change" button 71 on the update selection screen 70 being displayed (opt: [update], C12), the auxiliary program 42 executes a capability update procedure (C15). The capability update procedure will be described with reference to a sequence diagram of FIG. 8.

In the capability update procedure, the auxiliary program 42 outputs a capability update instruction to the general-purpose printing program 41 (D01). When the general-purpose printing program 41 receives the capability update instruction, the general-purpose printing program 41 outputs a capability update request to the auxiliary program 42 (D02). The capability update request is an instruction from the general-purpose printing program 41 to the auxiliary program 42 requesting information for updating the capability information held in the general-purpose printing program 41. The auxiliary program 42 can receive a capability update request from the general-purpose printing program 41 by outputting the capability update instruction to the general-purpose printing program 41.

Upon receiving the capability update request, the auxiliary program 42 acquires the current capability information from the printer 2 (D03). The auxiliary program 42 may acquire the capability information by making a direct request to the printer 2, or may acquire the capability information via the general-purpose printing program 41 by making a request to the general-purpose printing program 41. The auxiliary program 42 updates and stores the capability information stored in the memory 12 (D04). D04 is an example of the update process.

Then, the auxiliary program 42 passes the capability information to the general-purpose printing program 41 based on the information acquired in D03 (D05). As a result, the general-purpose printing program 41 updates the capability information indicating the capability of the printer 2, that is, the information stored in the memory 12 at A34 in FIG. 2 or B23 in FIG. 4 (D06). D05 is an example of the update process.

The auxiliary program 42 acquires from the general-purpose printing program 41 the information on the print settings that the general-purpose printing program 41 has set based on the updated capability information (D11). The auxiliary program 42 updates and displays the detailed setting screen 60 displayed in C05 of FIG. 5 based on the acquired information on the print settings (D12). D12 is an example of the first screen update process. The auxiliary program 42 updates the detailed setting screen 60 based on the updated capability information, thereby displaying selectable parameters as options in response to changes in the capability of the printer 2. The auxiliary program 42 may update the detailed setting screen 60 based on the capability information acquired in D03 without performing D11.

That is, when the auxiliary program 42 receives a change operation to a specific item on the detailed setting screen 60 displayed by the auxiliary program 42, the auxiliary program 42 displays the update selection screen 70 to receive a user operation. Further, if a long time has passed since the previous update, the auxiliary program 42 displays the update selection screen 70 to receives a user operation. Then, when the auxiliary program 42 receives a selection for updating by the user, a capability update procedure is executed. Therefore, the user can update the capability information when the detailed setting screen 60 is being displayed.

Further, when the capability information is updated as a result of the selection to update the capability information, the auxiliary program 42 updates a display content of the detailed setting screen 60, for example, the parameters to be displayed in a selectable manner. Therefore, the user can select a parameter that is suitable for the updated capability information. For example, if a parameter that is selected before the update becomes un-selectable due to the update of the capability information, the auxiliary program 42 may automatically change it to a selectable parameter and display it, or may display a message prompting the user to change the parameter. This makes it highly likely that a change in the capability of the printer can be accommodated even while the detailed setting screen 60 is being displayed and detailed print settings are being received.

The detailed setting procedure of FIG. 5 will be described again. When the auxiliary program 42 receives an operation on the "not change" button 72 on the update selection screen 70 being displayed, the auxiliary program 42 does not execute the capability update procedure. The auxiliary program 42 may provide a check box on the update selection screen 70 for not displaying the screen from the next time onwards. When the check box is operated, the auxiliary program 42 may not accept any further selections and may assume that the same selection is made.

Further, even if the auxiliary program 42 receives a user operation on a specific item, if the elapsed time since the last update of the capability information is short, the auxiliary program 42 may not display the update selection screen 70 or execute the capability update procedure. In addition, for example, in a case where a user operation on a specific item only displays a list of parameters and does not involve an instruction to change a parameter, the update selection screen 70 may not be displayed and the capability update procedure may not be executed. If the elapsed time is short or if only parameters are displayed, it is unlikely that the capability of printer 2 is changed, and thus by not receiving the update selection, the time and effort of the user and the processing load for updating can be reduced.

When the auxiliary program 42 receives an operation on the update button 61 on the detailed setting screen 60 being displayed (opt: [operation on update button]), the auxiliary program 42 executes the capability update procedure shown in FIG. 8 (C22), similar to C15. The update button 61 is an example of the second operator. D12 of the capability update procedure executed in C22 is an example of the second screen update process.

The auxiliary program 42 displays the detailed setting screen 60 including the update button 61, and when an operation on the update button 61 is received, executes the capability update procedure. Therefore, the user can update the capability information at any time while the detailed setting screen 60 is being displayed. Further, when the capability information is updated as a result of the capability information update being selected, the auxiliary program 42 also updates the display content of the detailed setting screen 60. Therefore, this makes it highly likely that a change in the capability of the printer can be accommodated even while the detailed setting screen 60 is being displayed and detailed print settings are being received.

Further, when the auxiliary program 42 receives an instruction to end the print settings on the detailed setting screen 60 (opt: [end instruction], C31), the auxiliary program 42 passes the information on the print settings to the general-purpose printing program 41 and notifies the general-purpose printing program 41 of the end of the detailed settings (C32). When an operation on the "OK" button 62 is received in the detailed setting screen 60, the auxiliary program 42 passes the information on the print settings being displayed to the general-purpose printing program 41. Further, when an operation on the "Cancel" button 63 is received, the auxiliary program 42 does not pass the information on the print settings received on the detailed setting screen 60 to the general-purpose printing program 41, and returns to the print setting before the detailed setting screen 60 is displayed.

The general-purpose printing program 41 notifies the editing application 43 of the end of the detailed settings (C33). This allows the general-purpose printing program 41 and the editing application 43 to reflect the changed capabilities of printer 2 on the print setting screen displayed in A35 if the capabilities of printer 2 change after the printer 2 is selected. When the editing application 43 receives a print instruction from the user, the editing application 43 passes image data representing an image to be printed to the general-purpose printing program 41 and instructs the general-purpose printing program 41 to perform printing on the printer 2. Therefore, the general-purpose printing program 41 and the auxiliary program 42 can execute a process for printing with print settings suited to the capabilities of the printer 2.

As described above in detail, the auxiliary program 42 according to the aspect causes the CPU 11 of the PC 1 to receive an operation for updating the capability information via the user IF 13. In response to receiving the operation, the auxiliary program 42 causes the CPU 11 to acquire the capability information from the printer 2 and update the capability information stored in the memory 12. Therefore, after receiving the operation, the CPU 11 can use print settings that reflect the capability information of the printer 2 at that time. This makes it highly likely that even after the printer 2 is selected, a change in the capability of the printer 2 can be accommodated by receiving the user operation.

The embodiments disclosed in the present specification are merely an example, and does not limit the present invention. Therefore, various improvements and modifications can be naturally made to the technique disclosed in the present specification without departing from the gist of the present invention. For example, the printer 2 connected to the PC 1 is not limited to a single-function printer, but may be any device that has a printing function, such as a multi function device, a copying machine, or a fax machine. The number of printers 2 connected to the PC 1 is not limited to the illustrated example, and may be two or more.

Further, for example, the examples of the screens displayed on the user IF 13 are all examples, and are not limited to the shown examples. Further, a wording, a shape, a background, or the like of the object displayed in each screen shown in the drawing may be any type. For example, FIG. 3 illustrates the print setting screen D2 including one information display field 52, but the arrangement, shape, size, number, and the like of the information display field 52 are not limited to the example of FIG. 3. The information display field 52 may be omitted. Also, instead of providing the update button 521 in the information display field 52, a button for receiving an update instruction may be provided in the basic print setting selection field 53.

Further, although an example has been described in the embodiment in which an instruction to update the capability information by a user operation is received in a plurality of procedures, the auxiliary program 42 may receive the instruction to update the capability information in at least one procedure. Specifically, it is sufficient that at least one of the update button 521 on the print setting screen D2, the "change" button 71 on the update selection screen 70, and the update button 61 on the detailed setting screen 60 is displayed, and the auxiliary program 42 receive a user operation.

Further, in the print setting procedure shown in FIG. 2, the capability information of the printer 2 is acquired when it is determined that there is no cache in A21 after the auxiliary program 42 is activated in A13, but the timing of determining whether there is a cache and the timing of acquiring the capability information are not limited to this. For example, the auxiliary program 42 may determine whether there is a cache even when it is activated in C05.

In addition, after the print setting screen D2 is displayed by the general-purpose printing program 41, if the user operates to change a normally used printer from another printer to the printer 2 via the OS 21, the general-purpose printing program 41 may also activate the auxiliary program 42. Furthermore, the auxiliary program 42 may be activated not only when printing is selected, but also when, for example, the printer 2 is selected as a device setting. Even in these cases, the auxiliary program 42 may display a setting screen including an operator for receiving an instruction to update the capability information.

In the embodiments, although only the printing operations have been described in detail as the operations of the auxiliary program 42, the auxiliary program 42 may also have other roles. The program that executes the process of the present embodiment is not limited to the auxiliary program 42, but may be any program that receives an instruction from the OS 21 or the general-purpose printing program 41 when printing is performed using the general-purpose printing program 41. For example, a print workflow application (Print workflow) whose specifications have been published by Microsoft may be used.

Further, an execution timing of the auxiliary program 42 is not limited to the example of the embodiments. For example, it may be executed in response to a direct execution instruction from the OS 21, or may be a resident auxiliary program 42. If it is resident, the auxiliary program 42 may receive an execution command and perform the above-described operations.

In any flowchart disclosed in the embodiment, an execution order of a plurality of processes in any of a plurality of steps can be freely changed or can be executed in parallel within a range in which no contradiction occurs in a processing content.

The processing disclosed in the embodiments may be executed by hardware such as a single CPU, a plurality of CPU, and an ASIC, or a combination thereof. In addition, the processes disclosed in the embodiments can be implemented in various modes such as a recording medium in which a program for executing the processes is recorded, or a method.

The support program disclosed in the present specification causes a computer of an information processing device to receive an operation for updating the capability information via a user interface of the information processing device. The support program causes the computer to acquire and update the capability information from the printer in response to reception of the operation. Therefore, after the operation is received, the computer can use the print setting that reflects the capability information of the printer at that time. This makes it highly likely that even after the printer is selected, a change in the capability of the printer can be accommodated by receiving the user operation.

An information processing device incorporating the support program, a computer-readable storage medium storing the support program, and a control method for implementing a function of the support program are also novel and useful.

The technique disclosed in the present specification implements the technique that can easily accommodate the current capability of a printer in an information processing device in which an OS-standard general-purpose printing program is incorporated.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A non-transitory computer readable storage medium storing a support program that is executable by a computer of an information processing device, corresponds to a printer connected to the information processing device, and supports a general-purpose printing program incorporated in an operating system of the information processing device,
wherein at least one of the general-purpose printing program and the support program causes the computer to communicate with the printer to acquire capability information indicating a capability of the printer, and store the acquired capability information in a memory of the information processing device,
wherein the general-purpose printing program is configured to cause the computer to receive a print setting for causing the printer to execute printing based on the capability information stored in the memory,
wherein the support program is configured to cause the computer to execute a generation process of generating display data to be displayed on a first print setting screen, in which the first print setting screen is a print setting screen to be displayed by an editing application program incorporated in the information processing device, the first print setting screen includes a first operator that receives an operation for updating the capability information, and the generated display data is passed to the editing application program via the general-purpose printing program to display the first print setting screen according to the display data, and
wherein the support program further causes the computer to execute:
an acquisition process of acquiring operation information from the editing application program when an operation on the first operator included in the first print setting screen is received via a user interface of the information processing device; and
an update process of acquiring the capability information from the printer in response to the operation information being acquired and updating the capability information stored in the memory.

2. The storage medium according to claim 1,
wherein the support program causes the computer, in response to the operation information being acquired, to execute the update process that instructs the general-purpose printing program to update the capability information.

3. The storage medium according to claim 1,
wherein the support program causes the computer to execute, when the update process is executed in response to the operation information being acquired, the generation process of generating the display data for displaying the first print setting screen that reflects the capability information updated in the update process, and the generated display data is passed to the editing application program via the general-purpose printing program to update the first print setting screen being displayed.

4. A non-transitory computer readable storage medium storing a support program that is executable by a computer of an information processing device, corresponds to a printer connected to the information processing device, and supports a general-purpose printing program incorporated in an operating system of the information processing device,
wherein at least one of the general-purpose printing program and the support program causes the computer to communicate with the printer to acquire capability information indicating a capability of the printer, and store the acquired capability information in a memory of the information processing device,
wherein the support program is configured to cause the computer to receive a print setting for causing the printer to execute printing based on the capability information stored in the memory,
wherein the support program causes the computer to execute a receiving process of receiving an operation for updating the capability information via a user interface of the information processing device, and
wherein the support program further causes the computer to execute, in response to reception of the operation in the receiving process, an update process of acquiring the capability information from the printer and updating the capability information stored in the memory.

5. The storage medium according to claim 4,
wherein the support program causes the computer to execute, when a display instruction to display a second print setting screen is received, in which the second print setting screen is a print setting screen to be displayed by the support program, a display process of displaying the second print setting screen using the user interface of the information processing device,
wherein the support program further causes the computer to execute a first selection process of receiving, via the user interface of the information processing device, a selection of whether to update the capability information when a change operation is performed on a specific item corresponding to a capability of the printer that is possibly changed among setting items included in the second print setting screen, and
wherein in the receiving process, the selection of whether to update the capability information in the first selection process is received via the user interface of the information processing device as the operation for updating the capability information.

6. The storage medium according to claim 5,
wherein the support program causes the computer to execute, when the selection of whether to update the capability information is received in the receiving process and the update process is executed, a first screen update process of updating the second print setting screen based on the capability information updated in the update process.

7. The storage medium according to claim 4,
wherein the support program causes the computer to execute, when a display instruction to display a second print setting screen is received, in which the second print setting screen is a print setting screen to be displayed by the support program, a display process of displaying the second print setting screen using the user interface of the information processing device,
wherein the support program further causes the computer to execute a second selection process of receiving, via the user interface of the information processing device, a selection of whether to update the capability information when an elapsed time since the previous execution of the update process exceeds a threshold time, and
wherein in the receiving process, the selection of whether to update the capability information in the second selection process is received via the user interface of the information processing device as the operation for updating the capability information.

8. The storage medium according to claim 4,
wherein the support program causes the computer to execute, when a display instruction to display a second print setting screen, in which the second print setting screen is a print setting screen to be displayed by the support program, a display process of displaying the second print setting screen using the user interface of the information processing device, in which the second print setting screen includes a second operator that receives an operation for updating the capability information, and
wherein in the receiving process, an operation on the second operator included in the second print setting screen is received via the user interface of the information processing device as the operation for updating the capability information.

9. The storage medium according to claim 8,
wherein the support program causes the computer to execute, when the operation on the second operator is received in the receiving process and the update process is executed, a second screen update process of updating the second print setting screen based on the capability information updated in the update process.

10. The storage medium according to claim 4, wherein the support program causes the computer, in response to reception of the operation in the receiving process, to execute the update process that instructs the general-purpose printing program to update the capability information.
